(19) United States
(12) Patent Application Publication
(10) Pub. No.: US 2025/0301976 A1
(43) Pub. Date: Oct. 2, 2025

(54) HYDROPONIC SYSTEM

(71) Applicant: BARNSTORFER KUNSTSTOFFTECHNIK GMBH & CO. KG, Barnstorf (DE)

(72) Inventor: Florian BORCHERS, Goldenstedt (DE)

(73) Assignee: BARNSTORFER KUNSTSTOFFTECHNIK GMBH & CO. KG, Barnstorf (DE)

(21) Appl. No.: 19/071,962

(22) Filed: Mar. 6, 2025

(30) Foreign Application Priority Data
Mar. 26, 2024 (DE) 20 2024 101 513.4

(51) Int. Cl. A01G 31/02

(52) U.S. Cl. CPC A01G 31/024

(57) ABSTRACT

A hydroponic system having a channel element and a cover element, wherein the cover element is movably connected to the channel element along a longitudinal side by a connector and the connector extends over the full length of the channel element and/or of the cover element.

The invention relates to a hydroponic system according to the preamble of claim 1. A channel element and a cover element made of in particular extruded plastic are provided.

Hydroponic systems are used to supply young plants with water, nutrients and oxygen. In or over a channel, the young plants are kept free of soil—with or without substrate—and supplied with water and nutrients. Excess liquid is collected in the channel and drained or circulated. It is also possible for liquid to be supplied via the channel itself, depending on the type of hydroponic system.

The channel is provided with a cover, which has openings for the young plants. The cover reduces or prevents loss of liquid due to evaporation. The cover also protects the roots of the young plants from external influences. The channel can be relatively long. Placing the cover in position and closing it are tasks which require time and skill.

The object of the present invention is to create a hydroponic system with an easy-to-handle cover.

To solve the problem, the hydroponic system according to the invention has the features of claim 1. In particular, provision is made for the cover element to be movably connected to the channel element along a longitudinal side by a connecting means. By virtue of the cover element being connected to the channel element, the cover element can be quickly and easily placed accurately in position and closed.

According to a further concept of the invention, provision can be made for the connecting means to extend, in particular with a full surface area, over the full length of the channel element and/or of the cover element. The connecting means is thus a strip parallel to the channel element and cover element, as such relatively stable and supplements the effect of the cover element.

According to a further concept of the invention, provision can be made for the connecting means to consist of a material which is softer than the channel element and/or the cover element. The channel element and/or cover element should be as stable as possible. On account of its material properties, the connecting means can allow the cover element to move relative to the channel element. The connecting means is preferably inherently elastic, and so repeated movement is possible.

According to a further concept of the invention, provision can be made for the connecting means to have a smaller wall thickness than the channel element and/or the cover element. The connecting means should, as far as possible, be less dimensionally stable than the channel element and the cover element. This can be made possible by the smaller wall thickness.

According to a further concept of the invention, provision can be made for the channel element and cover element to be co-extruded with the connecting means, and for the connecting means to be firmly connected in particular to the channel element and/or to the cover element. Manufacturing by means of co-extrusion enables cost-effective mass production.

According to a further concept of the invention, provision can be made for the channel element and/or cover element to consist of rigid PVC, PP, PE or ABS. These materials ensure that the channel element and cover element are highly dimensionally stable.

According to a further concept of the invention, provision can be made for the connecting means to consist of soft PVC, TPU (thermoplastic elastomers based on urethane), TPO (thermoplastic elastomers based on olefin), TPE (thermoplastic elastomers) or PE (polyethylene). These materials allow the connecting means to be less dimensionally stable.

According to a further concept of the invention, provision can be made so that, on a longitudinal channel edge facing the connecting means, the channel element has a channel-side groove for receiving a corresponding channel-side connecting-means edge. This allows a good durable connection between the connecting means and channel element at this location.

According to a further concept of the invention, provision can be made for the channel-side connecting-means edge to have a profile bead, and for the channel-side groove on the channel edge to have a cross-sectional widening on the inside for receiving the profile bead. This allows the connecting-means edge to be held in a form-fitting manner in the channel-side groove.

According to a further concept of the invention, provision can be made so that, on a cover edge facing the connecting means, the cover element has a cover-side groove for receiving a corresponding cover-side connecting-means edge. This allows a good durable connection between the connecting means and cover element.

According to a further concept of the invention, provision can be made for the cover-side connecting-means edge to have a profile bead, and for the cover-side groove to have a cross-sectional widening on the inside for receiving the profile bead. This allows the connecting-means edge to be held in a form-fitting manner in the cover-side groove.

According to a further concept of the invention, provision can be made for the channel edge facing the connecting means to be formed with a thickening in the region of the channel-side groove. This allows the formation of a sufficiently large groove in the channel edge.

According to a further concept of the invention, provision can be made so that, below the channel-side groove, the thickening of the channel edge has an extension, which extends below the connecting means. The extension can form a rest for the cover edge. Accordingly, the extension preferably extends at least over the width of the connecting means.

According to a further concept of the invention, provision can be made so that, in the region of the cover-side groove, the cover edge facing the connecting means has a thickening. The thickening allows the cover edge to accommodate a sufficiently large groove.

According to a further concept of the invention, provision can be made for the thickening of the cover edge to rest on an extension of the thickening of the channel edge or at least to be located above the extension. The connecting means extends above the extension and is covered by the same in the downward direction.

According to a further concept of the invention, provision can be made so that, on a cover edge opposite to the connecting means, the cover element has a U profile, which can enclose an adjacent channel edge. The U profile allows the cover edge to be positioned securely on the channel edge.

According to a further concept of the invention, provision can be made for the U profile to have a lower crosspiece and an upper crosspiece, wherein the lower crosspiece is led vertically downwards from the upper crosspiece and then runs parallel to the upper crosspiece. It is thus possible for the cover element to be smooth on its upper side, without any elevations or the like.

According to a further concept of the invention, provision can be made for the U profile to have a lower crosspiece and an upper crosspiece, wherein the lower crosspiece parallel to the upper crosspiece, in the direction of the adjacent channel edge, is shorter than the upper crosspiece. The cover element can thus easily be prevented from dropping down under the adjacent channel edge at this location.

According to a further concept of the invention, provision can be made so that on the inside, on a floor, the channel element has a plurality of longitudinal crosspieces, in particular at equal distances from one another and/or with a height of no more than 10% of the overall height of the channel element. The longitudinal crosspieces increase the dimensional stability against bending without significantly restricting the volume available for the plants in the channel element.

According to a further concept of the invention, provision can be made for the channel element to have a plurality of longitudinal crosspieces on the outside, under a floor, at least in each case one longitudinal crosspiece adjacent to a side wall and/or at a distance from the adjacent side wall of no more than 5% of the overall width of the channel element. The longitudinal crosspieces under the floor act as feet and, at the same time, increase the dimensional stability against bending.

According to a further concept of the invention, provision can be made for the channel element to have a floor, side walls and roof walls, which are angled obliquely in relation to the side walls. The obliquely sloping roof walls give the plastic channel 10 a hexagonal profile overall, starting from a rectangular profile, wherein upper edges of the rectangular profile are bevelled.

According to a further concept of the invention, provision can be made for the cover element to have openings for the through-passage of plants. The arrangement of the openings in the cover element means that the channel element does not require any additional work to be carried out on it.

According to a further concept of the invention, provision can be made for the openings to be punched out. Punching out the openings enables efficient manufacturing in large numbers and is also possible in conjunction with the abovementioned co-extrusion.

The channel element, cover element and connecting means are preferably profiles. This results in open ends, which are closed off in particular by additional end caps. The end caps advantageously enclose the open ends completely, at least from a floor of the channel element to some way up the height thereof, preferably so that they extend above the cover element and the connecting means.

Further features of the invention can be gathered from the claims and from the rest of the description. Preferred exemplary embodiments of the invention will be explained in more detail hereinbelow with reference to drawings, in which:

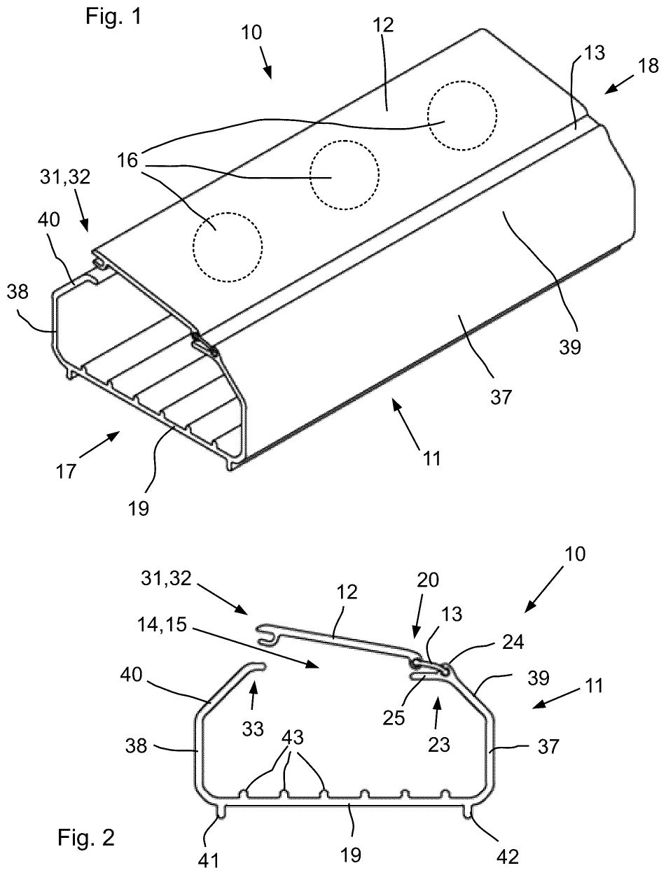

FIG. 1 shows a perspective illustration of a plastic channel of a hydroponic system,

FIG. 2 shows an end view of the plastic channel according to FIG. 1,

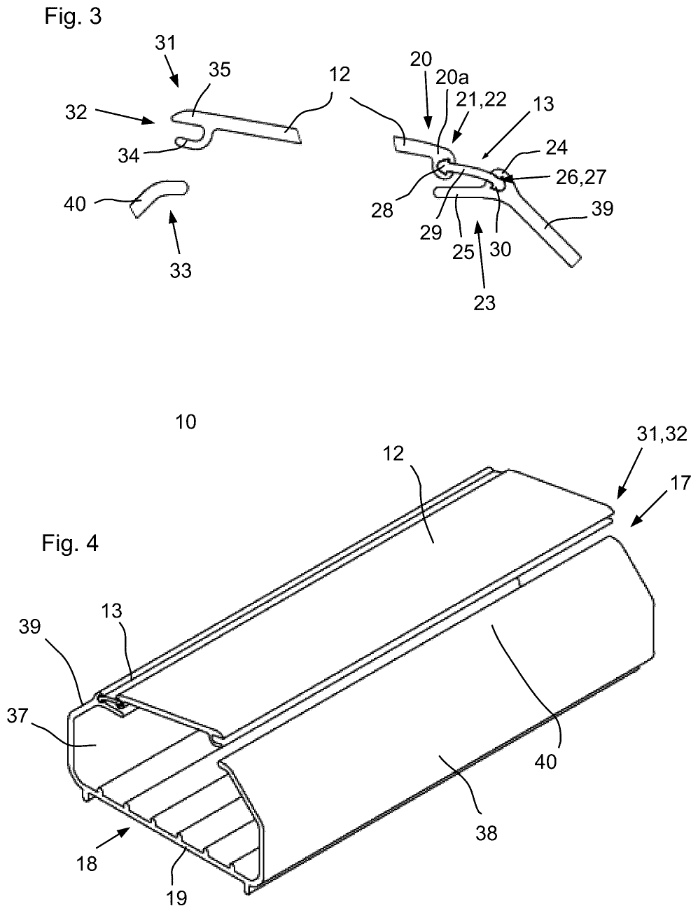

FIG. 3 shows an enlarged detail from FIG. 2, and

FIG. 4 shows the plastic channel according to FIG. 1 in a perspective illustration rotated through 180°.

A hydroponic system for supplying young plants has different components, depending on the system type. A tank or a tub, in which water or a nutrient solution are present or collected, are always provided. In modern systems, the tanks used are plastic channels 10 which can be produced industrially and in large numbers.

The plastic channel 10 here consists of a lower channel element 11, an upper cover element 12 and a connecting means 13 for connecting the cover element 12 to the channel element 11. The cover element 12 can completely cover a longitudinally directed opening gap 14 on an upper side 15 of the channel element 11. The channel element 11 and connecting means 13 are each formed with a full surface area. The cover element 12 has a plurality of openings 16, which follow one after the other in the longitudinal direction of the plastic channel 10 and are intended for receiving the young plants. The openings 16 are only indicated here by dashed lines.

In order to form a largely closed system, the plastic channel 10 has end caps (not shown) at both ends 17, 18. These end caps enclose the ends 17, 18 and, when the cover element 12 is resting on the channel element 11, extend above the height of the cover element, at least over part of the height of the channel element 11, starting from a floor 19 of the channel element 11.

The channel element 11, cover element 12 and connecting means 13 here are profiles formed by extrusion. In this case, the connecting means 13 is connected in a form-fitting manner, on the one hand, to the channel element 11 and, on the other hand, to the cover element 12. Co-extrusion allows the plastic channel 10 to be produced in a continuous process with all the elements 11, 12, 13. Since the cover element 12 is connected to the connecting means 13 only on a longitudinal cover edge 20, the cover element 12 can be swung up relative to the channel element 11 during the co-extrusion or immediately following the co-extrusion. In this position, the cover element 12 can be straightforwardly provided with the aforementioned openings 16, for example by the cover element 12 being punch cut on a cutting board.

On the cover edge 20, in the direction of the connecting means 13, the cover element 12 has a groove 21 for receiving a corresponding connecting-means edge 22. The cover edge 20 rests on a channel edge 23. In this region, the channel edge 23 has a thickening 24 with an adjoining extension 25. A groove 26 is formed in the thickening 24, a channel-side connecting-means edge 27 being held in the groove.

The connecting means 13 here has a profile comprising a cover-side profile bead 28, a central crosspiece 29 and a channel-side profile bead 30. The profile beads 28, 30, at the same time, form the connecting-means edges 22, 27 and are held in a form-fitting manner in the grooves 21, 26. Groove openings have a smaller cross section than the profile beads 28, 30. With the profile geometry formed in this way, the connecting means 13 extends above the extension 25.

On a cover edge 31 opposite to the connecting means 13, the cover element 12 has a U profile 32, which can enclose an adjacent channel edge 33. The U profile 32 has a lower crosspiece 34 and an upper crosspiece 35. The upper crosspiece 35 rests on the channel edge 33 when the cover element 12 is closed. The lower crosspiece 34 is slightly shorter than the upper crosspiece 35. The upper crosspiece 35 extends in continuation of a cover wall 36. The lower crosspiece 34 is led from the upper crosspiece 35, perpendicularly to the latter, and then runs parallel to the upper crosspiece 35.

The channel element 11 and/or cover element 12 is/are more rigid and/or less elastic than the connecting means 13. The connecting means preferably consists of soft PVC, TPU (thermoplastic elastomers based on urethane), TPO (thermoplastic elastomers based on olefin), TPE (thermoplastic elastomers) or PE (polyethylene). The channel element 11 and/or cover element 12 consist in particular of rigid PVC, polypropylene (PP), polyethylene (PE) or acrylonitrile butadiene styrene copolymer (ABS).

As a result of the materials used and/or the geometry described in respect of the cover element 12, opening gap 14 and connecting means 13, the cover element 12 can close the opening gap 14 and is secured in a form-fitting manner, after closing, against opening movement. The U profile 32 encloses the channel edge 33. For opening purposes, the cover element 12 has to be pushed against the opposite channel edge 23, which is made possible by the material and the geometry of the connecting means 13.

The channel element 11 has a specific profile, comprising the floor 19, side walls 37, 38, roof walls 39, 40, which are angled obliquely in relation to the side walls, and the channel edges 23, 33. The floor 19 has on the underside, in the vicinity of the side walls 37, 38, a respectively downwardly directed crosspiece 41, 42. On the upper side, the floor 19 has a plurality of upwardly directed crosspieces 43, which are at equal distances from one another and, in the same way as the crosspieces 41, 42, run in the longitudinal direction of the channel element 11 and increase the stability thereof. The crosspieces 41 to 43 have a height of preferably no more than 10% of the overall height of the channel element 11. The lower crosspieces 41, 42 are each at a distance from the side wall of preferably no more than 5% of the overall width of the channel element 11.

The plastic channel 10 is co-extruded with the channel element 11, cover element 12 and connecting means 13. Such processes are generally known, and tried and tested, also in connection with the use of different materials. In the present case, the openings 16 can be made in the cover element 12 following the co-extrusion. For this purpose, the cover element can be positioned at a defined angle relative to the opening gap 14 and supported on a stable block while the openings 16 are being punched out.

The dimensions of the plastic channel 10 are adapted to use as part of a hydroponic system. A length of 3 to 6 m, a width of 10 cm and a height of 5 cm are preferred. The dimensions are examples only and can be adapted in dependence on the type of hydroponic system and the plants to be grown.

### LIST OF REFERENCE SIGNS

10 plastic channel
11 channel element
12 cover element
13 connecting means
14 opening gap
15 upper side (channel element)
16 openings (in the cover element)
17 end (plastic channel)
18 end (plastic channel)
19 floor (channel element)
20 cover edge
20a thickening (cover edge)
21 groove (cover element)
22 connecting-means edge (cover-side)
23 channel edge
24 thickening (channel edge)
25 extension (channel edge)
26 groove (channel edge)
27 connecting-means edge (channel-side)
28 profile bead (cover-side)
29 central crosspiece
30 profile bead (channel-side)
31 cover edge
32 U profile
33 channel edge
34 lower crosspiece
35 upper crosspiece
36 cover wall
37 side wall
38 side wall
39 roof wall
40 roof wall
41 crosspiece (downward)
42 crosspiece (downward)
43 crosspieces (upward)

1. A hydroponic system having a channel element and a cover element, wherein the cover element is movably connected to the channel element along a longitudinal side by a connecting means.

2. The hydroponic system according to claim 1, wherein the connecting means extends over the full length of the channel element and/or of the cover element.

3. The hydroponic system according to claim 1, wherein the connecting means consists of a material which is softer than the channel element and/or the cover element.

4. The hydroponic system according to claim 1, wherein the connecting means has a smaller wall thickness than the channel element and/or the cover element.

5. The hydroponic system according to claim 1, wherein the channel element and cover element are co-extruded with the connecting means, and in that the connecting means is firmly connected in particular to the channel element and/or to the cover element.

6. The hydroponic system according to claim 1, wherein the channel element and/or cover element consist(s) of rigid PVC, PP, PE or ABS.

7. The hydroponic system according to claim 1, wherein the connecting means consists of soft PVC, TPU, TPO, TPE or PE.

8. The hydroponic system according to claim 1, wherein, on a longitudinal channel edge facing the connecting means, the channel element has a channel-side groove for receiving a corresponding channel-side connecting-means edge.

9. The hydroponic system according to claim 8, wherein the channel-side connecting-means edge has a profile bead, and in that the channel-side groove on the channel edge has a cross-sectional widening on the inside for receiving the profile bead.

10. The hydroponic system according to claim 1, wherein, on a cover edge facing the connecting means, the cover element has a cover-side groove for receiving a corresponding cover-side connecting-means edge.

11. The hydroponic system according to claim 10, wherein the cover-side connecting-means edge has a profile bead, and in that the cover-side groove has a cross-sectional widening on the inside for receiving the profile bead.

12. The hydroponic system according to claim 8, wherein the channel edge facing the connecting means is formed with a thickening in the region of the channel-side groove.

13. The hydroponic system according to claim 12, wherein, below the channel-side groove, the thickening of the channel edge has an extension, which extends below the connecting means.

14. The hydroponic system according to claim 10, wherein, in the region of the cover-side groove, the cover edge facing the connecting means has a thickening.

15. The hydroponic system according to claim 14, wherein the thickening of the cover edge rests on an extension of the thickening of the channel edge or at least is located above the extension.

16. The hydroponic system according to claim 1, wherein, on a cover edge opposite to the connecting means, the cover element has a U profile, which can enclose an adjacent channel edge.

17. The hydroponic system according to claim 16, wherein the U profile has a lower crosspiece and an upper crosspiece, wherein the lower crosspiece is led vertically downwards from the upper crosspiece and then runs parallel to the upper crosspiece.

18. The hydroponic system according to claim 16, wherein the U profile has a lower crosspiece and an upper crosspiece, wherein the lower crosspiece parallel to the upper crosspiece, in the direction of the channel edge, is shorter than the upper crosspiece.

19. The hydroponic system according to claim 1, wherein on the inside, on a floor, the channel element has a plurality of longitudinal.

20. The hydroponic system according to claim 1, wherein the channel element has a plurality of longitudinal crosspieces on the outside, under a floor, at least in each case one longitudinal crosspiece adjacent to a side wall and/or at a distance from the adjacent side wall of no more than 5% of the overall width of the channel element.

21. The hydroponic system according to claim 1, wherein the channel element has a floor, side walls, and roof walls, which are angled obliquely in relation to the side walls.

22. The hydroponic system according to claim 1, wherein the cover element has openings for the through-passage of plants.

23. The hydroponic system according to claim 22, wherein the openings are punched out.
